(19) United States
(12) Patent Application Publication
(10) Pub. No.: US 2017/0350765 A1
(43) Pub. Date: Dec. 7, 2017

(54) TEMPERATURE SENSOR

(71) Applicant: Valeo Systemes de Controle Moteur, Cergy Saint Christophe (FR)

(72) Inventors: Nicolas Gelez, Cergy Saint Christophe (FR); Piotr Zakrzewski, Cergy Saint Christophe (FR); Pascal Castro, Cergy Saint Christophe (FR)

(73) Assignee: Valeo Systemes de Controle Moteur, Cergy Saint Christophe (FR)

(21) Appl. No.: 15/529,223

(22) PCT Filed: Nov. 24, 2015
(86) PCT No.: PCT/FR2015/053179

§ 371 Date: Aug. 11, 2017

(30) Foreign Application Priority Data
Nov. 24, 2014 (FR) 1461323

(51) Int. Cl. G01K 7/02; G01K 1/08; B23K 11/02; G01K 13/02

(52) U.S. Cl. CPC G01K 7/02; G01K 13/02; G01K 1/08; B23K 11/02; G01K 2205/02; G01K 2217/00

(57) ABSTRACT

Method for the manufacture of a temperature sensor with a thermocouple comprising the following successive steps:
a) introduction, in a support tube made of a ceramic material, of two thermocouple wires until they extend beyond said support tube;
b) welding the ends of said thermocouple wires extending beyond said support tube so as to form a thermocouple hot point;
c) introduction, at least partially, of the support tube into a reinforcement tube made of a stainless steel;
d) fixing a cap onto said reinforcement tube so as to protect said hot point.

### TECHNICAL FIELD

This invention relates to a temperature sensor comprising a thermocouple designed to measure temperatures that can vary between −40° C. and 1200° C. particularly in a heat engine of a motor vehicle.

### PRIOR ART

As shown in FIG. 1, a temperature-measuring device conventionally comprises a temperature sensor 2 extended by an extension cable 3 allowing the temperature sensor to be connected to a measuring device 4. The temperature sensor 2 conventionally comprises a metal protective sleeve 5 and a stop 6, mounted on the protective sleeve 5 and adapted according to the application envisaged.

The measuring device 4 is designed to interpret the electrical signal provided by the temperature sensor 2 and transmitted through the extension cable 3. This interpretation enables an assessment of the temperature to which the end of the temperature sensor is subjected.

Inside the protective sleeve 5, the temperature sensor 2 conventionally comprises a thermocouple 7 and a mineral insulation 8, conventionally aluminum or magnesium, which allows the thermocouple to withstand environmental stress and, in particular, high temperatures.

As shown in FIG. 2, the thermocouple 7 is an assembly of first and second conductor wires, 10 and 12, respectively, connected to each other and tip-to-tip in a hot point 13. The difference in potential ΔU at the terminals of the first and second conductor wires depends on the difference between the temperature at the hot point T₁ and the temperature T₀ at said terminals, according to the well-known Seebeck effect.

A temperature sensor comprising a thermocouple is used in particular in a heat engine, in which it is subjected to temperatures that can vary between −40° C. and 1200° C.

The conventional method of manufacturing a temperature sensor designed for such applications involves the following steps:

Firstly, a mineral insulated cable (MIC) is made.

A mineral insulated cable comprises a metal protective sleeve 5 and, inside the protective sleeve 5, two thermocouple wires 10 and 12 of suitable materials to form a thermocouple, the two thermocouple wires being isolated from one another and from the protective sleeve 5 by means of mineral insulation 8.

The mineral insulated cable is usually delivered in the form of a reel. It is then straightened, then cut into sections (FIG. 3a).

In order to form the connection between the two thermocouple wires, or “hot point” 13, some of the insulation material is extracted from one of the cable ends, for example by sanding or scraping, typically to a depth of between 2 and 10 mm. At this so-called “distal” end, the two thermocouple wires thus emerge from the insulation, while being encircled by the protective sleeve (FIG. 3b).

The two terminal parts of the thermocouple wires thus released are mechanically brought together until they are in contact with each other, then connected, for example by electric welding (FIG. 3c).

The emptied terminal part of the protective sleeve can then, optionally, be filled with insulating material, identical or different from the mineral insulation of the mineral insulated cable, then closed again, for example by electric welding, so as to protect the thermocouple (FIG. 3d).

Furthermore, after closing the protective sleeve 5 or before cutting the mineral insulated cable, conventionally a swaging 15 is made on the distal terminal part of the protective sleeve 5, conventionally by drawing or hammering. The swaging conventionally improves the response time of the temperature sensor.

Such a manufacturing method is difficult to automate, however, and currently involves delicate manual operations.

A need therefore exists for a solution that facilitates the automation of the manufacture of a temperature sensor with a thermocouple.

One aim of the invention is to meet this need.

### SUMMARY OF THE INVENTION

This invention proposes a method for the manufacture of a temperature sensor with a thermocouple comprising the following successive steps:
a) introduction, in a support tube made of a ceramic material, typically aluminum- (AL₂O₃) or magnesium- (MgO) based, but also made of other materials of the ceramic family or their mixtures AIN, BN, SiO₂, or others, of two thermocouple wires, until they extend beyond said support tube (at the end of the support tube opposite the end through which they were introduced into the support tube);
b) welding the ends of said thermocouple wires extending beyond said support tube so as to form a thermocouple hot point;
c) independently of the preceding steps, preferably after step d), the introduction, at least partially, of the support tube into a reinforcement tube made of a stainless steel, typically of the Inconel family, or a 310 S, or other stainless steel depending on the chosen application constraints.
d) fixing a cap onto said reinforcement tube so as to protect said hot point.

As will be seen in further detail in the rest of the description, such a method can be automated.

A method according to the invention can also comprise one or more of the following preferred optional features:
the support tube is partitioned;
the cap is swaged before being fixed onto the support tube;
the cap is shaped so as to cover over 90% of the outer lateral surface of the support tube;
the cap is made of Inconel, which gives it great measuring stability over time;
before fitting the cap, the cap is filled with an insulating material, preferably of powder, of a material chosen from aluminum, magnesium, aluminum nitride and/or boron nitride.

The invention also relates to a temperature sensor comprising a support tube made of a ceramic material, preferably partitioned, passed through longitudinally by two thermocouple wires, the two thermocouple wires projecting beyond the proximal and distal ends of the support tube, joining together outside the support tube, beyond the distal end of said support tube,

the parts of the thermocouple wire projecting beyond the distal end of the support tube, preferably being protected by a cap, preferably filled with an insulating material, said cap being fixed to a reinforcement tube in which is housed the support tube.

A temperature sensor according to the invention can in particular be manufactured by adopting a method according to the invention, possibly adapted so that the temperature sensor has one or more of the optional features described below.

A temperature sensor according to the invention may also comprise one or more of the following optional features:
the pair of materials of the first and second thermocouple wires is of the N or K type, preferably of the N type;
in a preferred embodiment, neither of the thermocouple wires is covered with an electrically insulating sleeve in the support tube;
at their proximal end, the thermocouple wires comprise electrical connection means, for example connection terminals enabling their connection to a measuring device and/or to an extension cable;
a thermocouple wire is not fixed in the longitudinal bore of the support tube that it passes through, more precisely, it is inserted into the bore of the tube;
the support tube comprises two longitudinal bores separated by a partition;
the support tube is an extruded tube;
the support tube is made of a ceramic material, typically aluminum- (AL₂O₃) or magnesium- (MgO) based, but also made of other materials of the ceramic family or their mixtures AIN, BN, SiO₂, or others;
the support tube is an electrically insulating material;
the cap has a swaging before being fixed onto the support tube. In order to have a short response time, the diameter of the swaging at the hot point is preferably less than 3.5 mm, or even less than 3 mm, or even less than 2 mm, or even less than 1.5 mm;
the cap is hermetically fixed onto the reinforcement tube;
the cap is fixed at a distal end of the reinforcement tube and/or onto the outer lateral surface and/or the inner lateral surface of the reinforcement tube;
the cap is fixed by laser welding onto the reinforcement tube;
the cap covers more than 10%, more than 30%, more than 60%, more than 90%, preferably substantially 100% of the outer lateral surface of the support tube;
the cap is shaped so as to abut against the support tube and/or the reinforcement tube, and/or comprises means of guiding the cap onto the support tube and/or the reinforcement tube;
the cap is filled with an insulating material, preferably in the form of powder, preferably of a material chosen from aluminum and/or magnesium and/or boron nitride and/or aluminum nitride, so that the thermocouple is insulated from the outside by said insulating material;
reinforcement tube preferably made of a stainless steel, typically of the Inconel family, or a 310 S, or other stainless steel depending on the chosen application constraints;
preferably, the outer diameter of the reinforcement tube is greater than 4 mm, preferably greater than or equal to 4.5 mm;
the wall of the reinforcement tube has a thickness greater than 0.2 mm and/or less than 1.3 mm;
a mechanical stop is fixed, preferably welded, onto the reinforcement tube.

The invention also concerns the use of a temperature sensor according to the invention in an environment in which the temperature can vary between −40° C. and 1200° C., and in particular can be above 800° C., above 900° C., above 1000° C., or above 1100° C., and in particular in a heat engine of a motor vehicle.

Lastly, the invention relates to a heat engine of a motor vehicle comprising a temperature sensor according to the invention, and a motor vehicle comprising a heat engine according to the invention. The temperature sensor can in particular be arranged in the exhaust manifold upstream of a turbine of a turbocharger or in a fuel or combustion intake pipe or in an exhaust pipe.

### BRIEF DESCRIPTION OF THE FIGURES

Further features and advantages of the invention will emerge from the following detailed description and an examination of the accompanying drawings, in which:

FIG. 1 is a schematic representation of a temperature sensor connected to a measuring device;

FIG. 2 is a schematic illustration of the principle of operation of a thermocouple;

FIG. 3 (FIGS. 3a to 3d) shows the method of manufacture of a temperature sensor according to the prior art;

FIG. 4 (FIGS. 4a to 4d) shows the different steps of a manufacturing method according to the invention.

### DEFINITIONS

“Proximal” and “distal” distinguish the two ends of a temperature sensor according to the invention. The “distal” end is that of the hot point.

“Hot point” conventionally describes the connection between the two thermocouple wires, regardless of its temperature.

“Comprising a,” “having a,” or “including a,” means “comprising at least one,” unless stated otherwise.

Identical reference numerals are used to identify the same parts in the different Figures.

### DETAILED DESCRIPTION

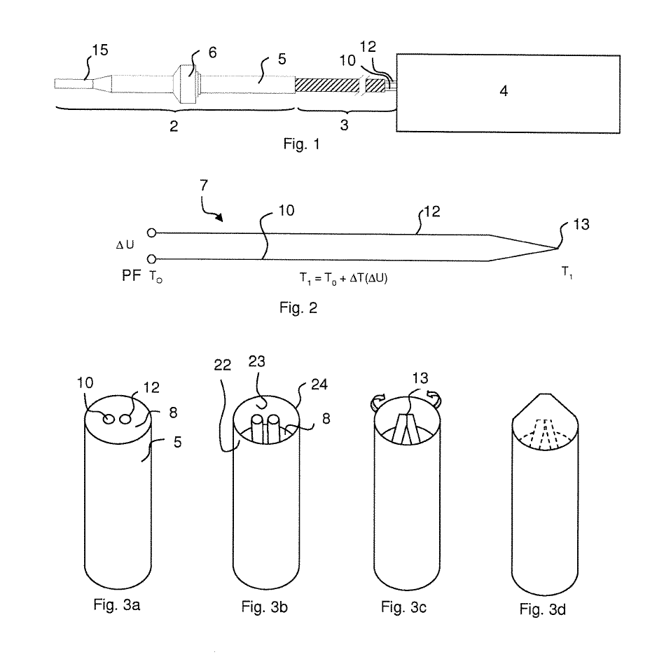

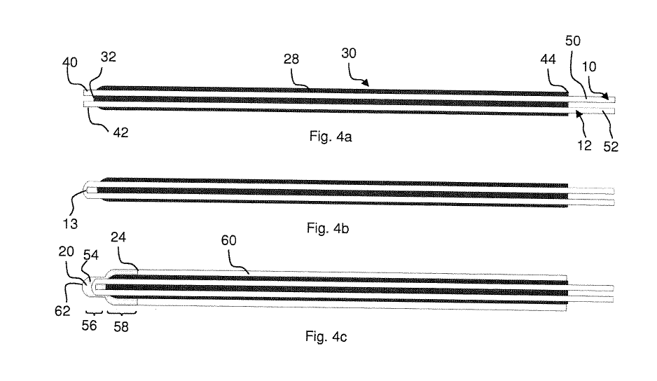

As FIGS. 1 to 3 have been described in the preamble; reference will now be made to FIG. 4.

Step a) involves passing the two thermocouple wires 10 and 12, designed to form a thermocouple, through one or more longitudinal bores 28 of a support tube 30 made of a ceramic material (FIG. 4a).

The support tube 30 is shaped so as to guide the thermocouple wires when they are introduced.

Preferably, the support tube 30 is a profile section, preferably shaped so that the bore or bores 28 have a cross section substantially identical to that of the thermocouple wires that they are designed to receive.

The support tube 30 can in particular be manufactured by extrusion.

Preferably, the support tube is partitioned. The partitioning of the support tube 30 advantageously enables any risk of electrical contact between the parts of the thermocouple wires introduced into said support tube to be avoided, even if they are not insulated by means of an electrically insulating sleeve.

In a variation not shown, the support tube 30 comprises one bore and the thermocouple wires are sheathed by means of an electrically insulating sleeve, thus avoiding any electrical contact between the thermocouple wires inside the support tube 30.

The thermocouple wires can be flexible or rigid. Preferably they have a substantially circular cross section.

The thermocouple wires are pushed until they project beyond the distal end 32 of the support tube 30. The projecting parts 40 and 42 of the thermocouple wires are completely or partially stripped so as to allow, in step b), the two thermocouple wires to come into contact.

The projecting parts 50 and 22 [sic!] of the thermocouple wires 10 and 12 that extend beyond the proximal end 44 can have a length greater than 5 cm, greater than 10 cm, greater than 20 cm, greater than 50 cm. Advantageously, these wires can thus serve as an extension cable 3 so as to electrically connect the temperature sensor 2 to the measuring device 4. Clearly, if the thermocouple wires are used as an extension cable, their projecting proximal end parts 50 and 52 must be electrically insulated. At their proximal end, the thermocouple wires 10 and 12 preferably comprise electrical connection means, for example connection terminals enabling their connection to the measuring device 4.

At step b), as shown in FIG. 4b, the distal terminal parts 40 and 42 of the thermocouple wires 10 and 12 are then connected to each other, i.e. placed in physical contact and electrically connected, in a final manner, so as to form a hot point 13. The connection is preferably achieved by hot welding.

At step c), the support tube is introduced into a stainless steel reinforcement tube 60. Step c) can precede step b), or even precede step a).

At step d), as shown in FIG. 4c, the thermocouple resulting from the connection of the two thermocouple wires is protected by means of a cap 20, preferably made of Inconel.

The cap 20 can be rigidly fixed to the reinforcement tube by any means, for example by means of an appropriate adhesive, so as to define a hermetic chamber 54 housing the projecting distal parts 40 and 42 of the thermocouple wires. Preferably, the chamber 54 is filled with an insulating material, preferably of powder, arranged in the cap before it is fixed onto the reinforcement tube. The powder insulating material can be in particular an aluminum powder or a magnesium powder.

Even more preferably, the cap 20 has a swaging 56 preferably extending to the distal end 32 of the support tube 30, as shown. Advantageously, a swaging 56 improves the response time of the sensor.

Advantageously, the creation of the swaging by means of a cap also improves mechanical strength, and particularly resistance to vibrations, compared to the prior art.

The swaging 56 can also serve as a mechanical stop facilitating fitting of the cap 20 onto the support tube 30. Even more preferably, the cap 20 comprises, in the extension of the swaging 56, a widened part 58 of a shape substantially complementary to the support tube 30, so that the support tube 30 can guide the cap 20 when it is being fitted.

Preferably, the support tube 60 extends the cap 20 in order to cover with it at least part, preferably all of the outer lateral surface of the protective sleeve. Preferably, the cap and the reinforcement tube together define an enclosure around the support tube. Preferably, this enclosure is sealed at least in the part of the temperature sensor that extends from the proximal end of the mineral insulated cable to the distal end 62 of the temperature sensor.

Even more preferably, the bore of the reinforcement tube 60 is of a shape that is substantially complementary to the outer lateral surface of the support tube 30.

In an embodiment, the cap 20 is fixed to the edge 24 of the distal end of the reinforcement tube 60, as shown in FIG. 4c. In an embodiment, the cap 20 and the reinforcement tube 60 form a monolithic assembly, i.e. the reinforcement tube 60 is made in one piece with the cap 20.

As it is now clear, the steps of a manufacturing method according to the invention are simple and can be automated. This results in a significant reduction in manufacturing costs.

Obviously, the invention is not limited to the embodiment described and represented, provided purely for illustrative purposes.

1. A method for the manufacture of a temperature sensor with a thermocouple comprising the following, performed successively:
introducing, in a support tube made of a ceramic material, two thermocouple wires until they extend beyond said support tube;
welding the ends of said thermocouple wires extending beyond said support tube to form a thermocouple hot point;
independently of introducing and welding the thermocouple wires, introducing, at least partially, of the support tube into a reinforcement tube made of a stainless steel; and
fixing a cap onto said reinforcement tube to protect said hot point.

2. The method according to claim 1, wherein the support tube is partitioned.

3. The method according to claim 1, wherein the cap is swaged before being fixed onto the support tube.

4. The method according to claim 1, wherein the cap is shaped so as to cover over 90% of the outer lateral surface of the support tube.

5. The method according to claim 1, wherein before fitting the cap, the cap is filled with an insulating material of a material chosen from aluminum and/or magnesium.

6. The method according to claim 1, wherein the cap is made of Inconel.

7. The temperature sensor manufactured by method according to claim 1.

8. The temperature sensor according to claim 7, wherein the temperature sensor is used in an environment at a temperature above 1000° C. and/or in which the temperature can vary between −40° C. and 1200° C.

9. A heat engine of a motor vehicle comprising a temperature sensor according to claim 7.
